(19) United States
(12) Patent Application Publication
(10) Pub. No.: US 2016/0225347 A1
(43) Pub. Date: Aug. 4, 2016

(54) LIQUID CRYSTAL DISPLAY PANEL

(71) Applicant: InnoLux Corporation, Miao-Li County (TW)

(72) Inventor: Yoshitaka HARUYAMA, Miao-Li County (TW)

(21) Appl. No.: 14/610,596

(22) Filed: Jan. 30, 2015

(51) Int. Cl. G09G 5/18; G09G 3/36

(52) U.S. Cl. CPC G09G 5/18; G09G 3/3696; G09G 2300/0426

(57) ABSTRACT

A liquid crystal display (LCD) panel driven by an overdrive technique comprises a first substrate, a second substrate, a liquid crystal layer, a first electrode and an alignment layer. The liquid crystal layer is disposed between the first substrate and the second substrate. The first electrode is disposed on the first substrate and comprises at least a first electrode portion extended toward a first direction. The first electrode is a line-symmetry structure and has a symmetry axis. An alignment layer is disposed on the first electrode and an included angle formed between the symmetry axis of the first electrode and an alignment direction of the alignment layer is less than or equal to 2°.

### BACKGROUND OF THE INVENTION

1. Field of Invention

The invention relates to a display panel and, in particular, to a liquid crystal display panel.

2. Related Art

With the progress of technologies, flat display devices have been widely applied to various kinds of fields. Especially, liquid crystal display (LCD) devices, having advantages such as compact structure, low power consumption, less weight and less radiation, gradually take the place of cathode ray tube (CRT) display devices, and are widely applied to various electronic products, such as mobile phones, portable multimedia devices, notebooks, LCD TVs and LCD screens.

Nowadays, the related products of the LCD device have become indispensible appliances. For example, LCD TVs are not only enlarged in panel size but also need to satisfy the strict requirement of the user's visual sense in image quality. Therefore, the developments of the companies are focused on the technology of presenting motion images.

In the conventional art, in order to solve the motion blur problem of the LCD device, the liquid crystal (LC) response is accelerated, and that is, the switching time of the LC molecules is reduced. Nowadays, a technique called the overdrive is used to accelerate the LC response, and the main principle thereof is to raise the driving voltage of the pixel to accelerate the rotation rate of the LC molecules and thus to improve the display quality of the motion image.

Moreover, in a conventional kind of pixel design, the lengthwise direction of the pixel electrode and the alignment direction of the LC are designed to form an angle (can be called the pre-twist angle). However, in such electrode design, if the extended overdrive technique is used to drive pixels and the driving voltage exceeds the maximum transmittance voltage of the pixel (the maximum transmittance voltage is the driving voltage whereby the pixel transmittance reaches maximum, which also can be called the white voltage), disclination will occur and the transmittance of the display panel is thus lowered down.

### SUMMARY OF THE INVENTION

An objective of the invention is to provide an LCD panel whereby the response of the LC molecules can be accelerated and the switching time can be reduced on the premise that the transmittance is not reduced, and therefore the motion blur problem can be improved and the display quality can be enhanced.

A liquid crystal display (LCD) panel comprises a first substrate, a second substrate, a liquid crystal layer, a first electrode and an alignment layer. The liquid crystal layer is disposed between the first substrate and the second substrate. The first electrode is disposed on the first substrate and comprises at least a first electrode portion extended toward a first direction. The first electrode is a line-symmetry structure and has a symmetry axis. An alignment layer is disposed on the first electrode and an included angle formed between the symmetry axis of the first electrode and an alignment direction of the alignment layer is less than or equal to 2°, and the liquid crystal display (LCD) panel is driven by an overdrive technique.

In one embodiment, the first electrode is a pixel electrode or a common electrode of the LCD panel.

In one embodiment, the first electrode portion has two opposite sides, and the included angle between the tangent direction at a point of one of the sides and the symmetry axis of the first electrode is between 0° and 10°.

In one embodiment, the first electrode portion is a bar-like shape.

In one embodiment, the first electrode portion has two opposite sides, and the included angle between one of the sides and the symmetry axis of the first electrode is between 0° and 10°.

In one embodiment, the first electrode further includes a second electrode portion connected with the first electrode portion, a contact hole is disposed on the second electrode portion, the first electrode portion adjacent to the contact hole has a first width, the first electrode portion far from the contact hole has a second width, and the first width is greater than or equal to the second width.

In one embodiment, the included angle formed between the first direction and the alignment direction is less than or equal to 2°.

In one embodiment, the first electrode comprises a plurality of the first electrode portions and a second electrode portion connected with the first electrode portions, the included angle formed between the first direction and the alignment direction of the alignment layer is between 178° and 182°.

In one embodiment, the interval between the adjacent first electrode portions near the second electrode portion is less than that far from the second electrode portion.

In one embodiment, one of the first electrode portions has two opposite sides, and one of the opposite sides away from the symmetry axis is substantially parallel to the alignment direction.

In one embodiment, an included angle formed between a normal direction of the first substrate and a long axis direction of the liquid crystal molecules of the liquid crystal layer is larger than 85° and smaller than 90°.

In one embodiment, the LCD panel is a fringe field switching (FFS) LCD panel or an in-plane switch (IPS) LCD panel.

In one embodiment, the LCD panel is driven by an extended overdrive technique.

In one embodiment, the LCD panel further comprises a data line electrically connected with the first electrode, and the first direction is substantially parallel to the data line.

In one embodiment, the LCD panel further comprises a second electrode disposed between the first electrode and the first substrate, and the area of the second electrode is larger than that of the first electrode.

In one embodiment, the LCD panel further comprises a black matrix layer disposed between the first substrate and the second substrate, and a part of the first electrode portion is covered by the back matrix layer.

As mentioned above, in the LCD panel of the invention, the pixel is disposed between the first substrate and the second substrate and includes an alignment layer and a first electrode. The alignment layer is disposed on the first electrode, and the first electrode is a line-symmetry structure and has a symmetry axis and is disposed on the first substrate. Besides, the first electrode includes at least a first electrode portion extended towards a first direction, and the included angle formed between the symmetry axis and the alignment direction of the alignment layer is less than or equal to 2°. By the electrode structure of the pixel and the relation between the first electrode portion of the first electrode and the alignment direction of the alignment layer, the pixel won't have the additional disclination and the transmittance is thus not reduced when the LCD panel is driven by the overdrive technique, especially by the extended overdrive voltage. Therefore, the LCD panel of this invention can accelerate the response of the LCD molecules and reduce the switching time on the premise that the transmittance is not reduced, and therefore the motion blur problem can be improved and the display quality can be enhanced.

### BRIEF DESCRIPTION OF THE DRAWINGS

The invention will become more fully understood from the detailed description and accompanying drawings, which are given for illustration only, and thus are not limitative of the present invention, and wherein:

FIG. 1A is a schematic sectional diagram of an LCD panel of an embodiment of the invention;

FIG. 1B is a schematic top view of the first electrode of the LCD panel in FIG. 1A;

FIGS. 1C and 1D are schematic diagrams showing the rotation of the LC molecules in relation to the first electrode in FIG. 1B when the pixel is not supplied and supplied with the driving voltage, respectively;

FIG. 1E is a schematic diagram showing the pre-tilt condition of the LC molecules of an embodiment;

FIG. 2A is a schematic diagram of a first electrode of another embodiment of the invention;

FIGS. 2B and 2C are schematic diagrams showing the rotation of the LC molecules in relation to the first electrode in FIG. 2A when the pixel is not supplied and supplied with the driving voltage, respectively;

FIG. 3 is a schematic diagram showing the switching time of the LC molecules with the varied driving voltage of the pixel transmitted to the first electrode in FIG. 2A according to an embodiment of the invention;

FIG. 4 is a schematic sectional diagram of an LCD panel of another embodiment of the invention; and

FIG. 5 is a schematic diagram of an LCD device of an embodiment of the invention.

### DETAILED DESCRIPTION OF THE INVENTION

The present invention will be apparent from the following detailed description, which proceeds with reference to the accompanying drawings, wherein the same references relate to the same elements.

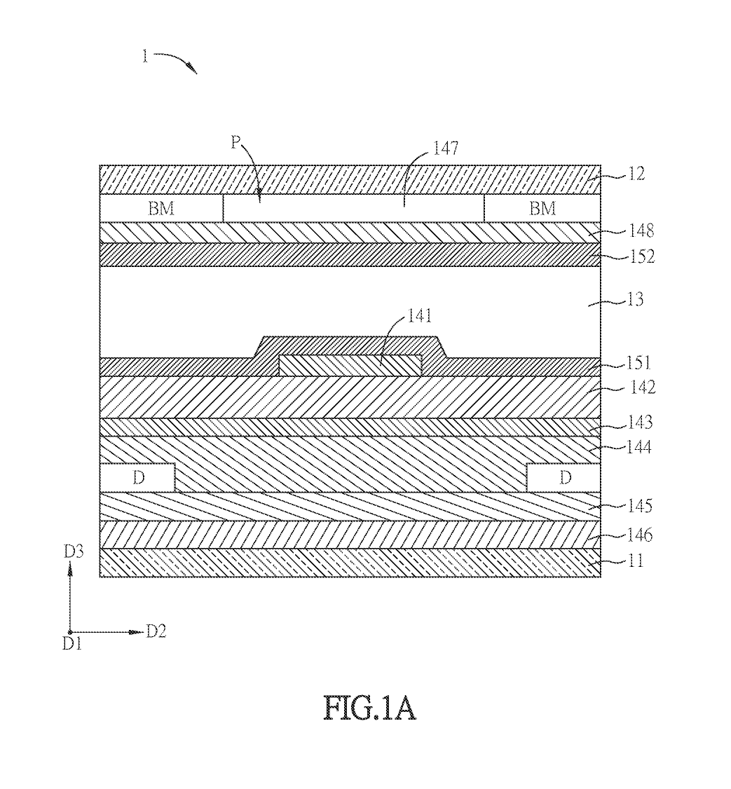

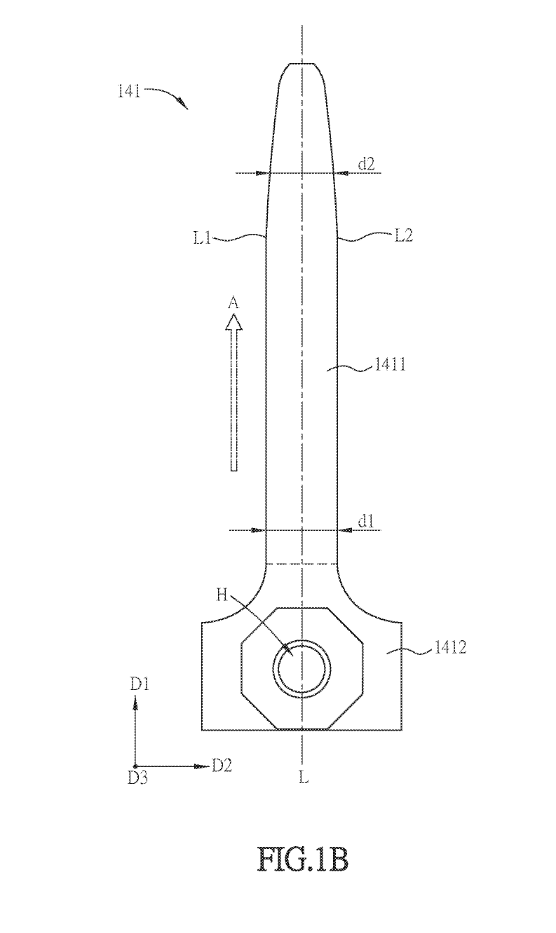

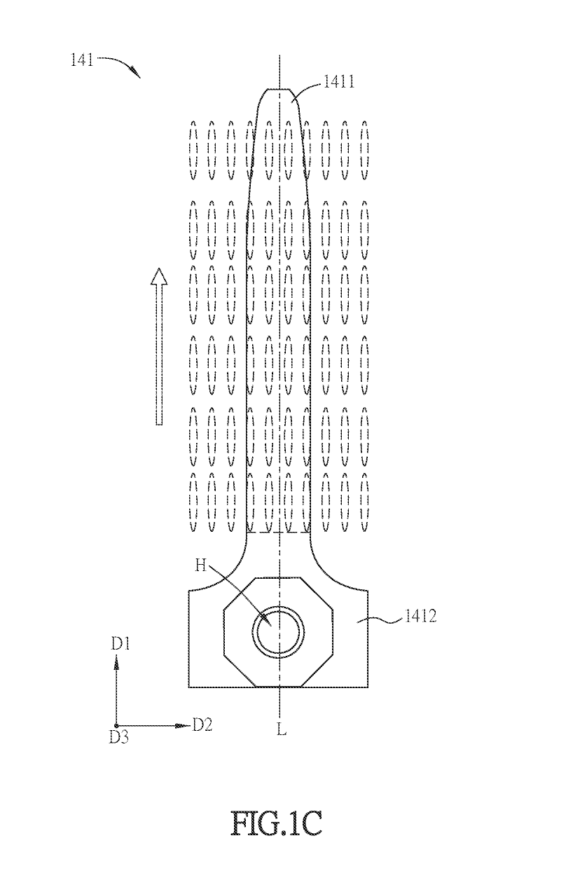

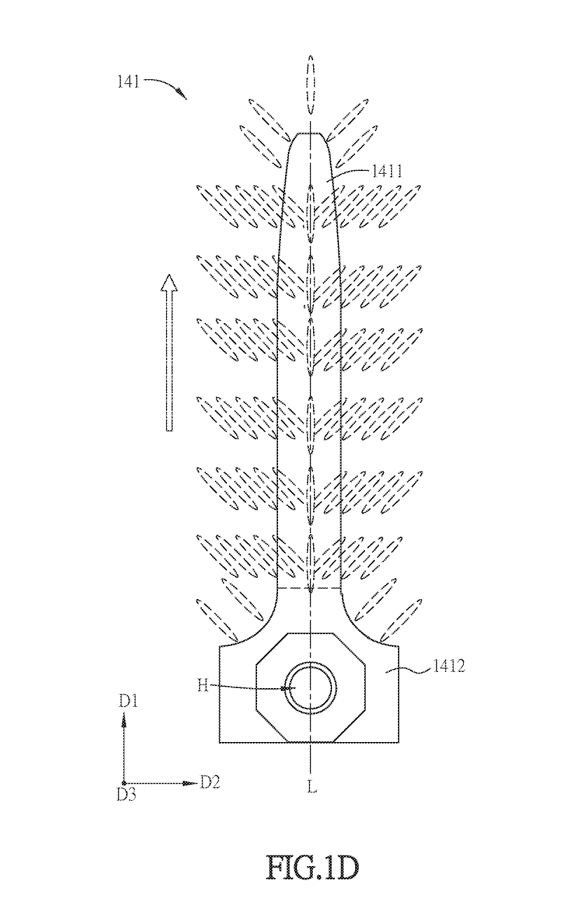

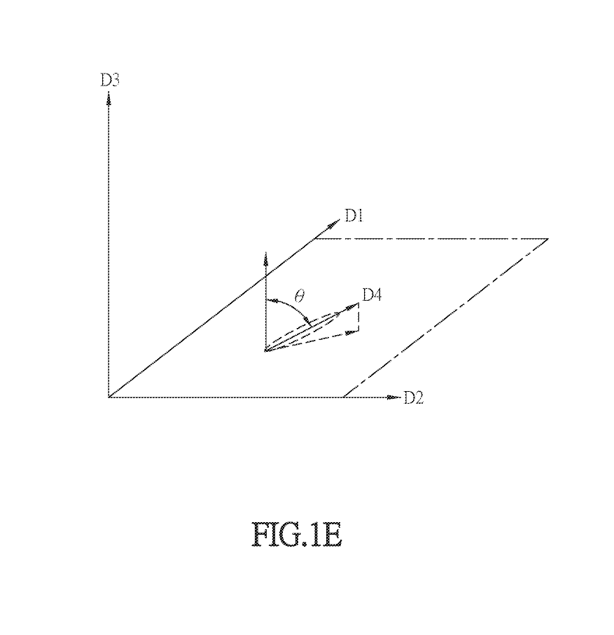

FIG. 1A is a schematic sectional diagram of an LCD panel 1 of an embodiment of the invention, and FIG. 1B is a schematic top view of the first electrode 141 of the LCD panel 1 in FIG. 1A.

As shown in FIGS. 1A and 1B, the LCD panel 1 of this embodiment can be a fringe field switching (FFS) LCD panel or an in-plane switch (IPS) LCD panel, or another LCD panel including the liquid crystal with horizontal driving type. Herein for example, the LCD panel 1 is a FFS LCD panel. Moreover, a first direction D1, a second direction D2 and a third direction D3 are shown in FIGS. 1A, 1B, and any two of them are perpendicular to each other. The first direction D1 is substantially parallel to the extending direction of the data line D of the LCD panel 1, the second direction D2 is substantially parallel to the extending direction of the scan line (not shown) of the LCD panel 1, and the third direction D3 is perpendicular to the first direction D1 and the second direction D2.

The LCD panel 1 is driven by an overdrive technique so that the motion blur problem can be reduced and the display quality can be enhanced, especially when driven by the extended overdrive voltage, the disclination phenomenon will be improved. Every stable state of the LC molecules corresponds to a specific voltage, so when the voltage of the pixel electrode is changed, the LC molecules will reach the target state after a certain response time instead of immediately rotating to the target state. However, the higher voltage difference results in the rapid rotation rate of the LC molecules (i.e. the shorter switching time). Accordingly, the overdrive technique is just to supply a driving voltage higher than the voltage of the target state in the beginning to accelerate the rotation of the LC molecules and therefore the response time is reduced.

As shown in FIG. 1A, the LCD panel 1 includes a first substrate 11, a second substrate 12 and a liquid crystal layer 13 disposed between the first substrate 11 and the second substrate 12. Each of the first substrate 11 and the second substrate 12 is made by a transparent material, and can be a glass substrate, a quartz substrate or a plastic substrate for example. The LCD panel 1 further includes a pixel array (not shown), which is disposed between the first substrate 11 and the second substrate 12 and includes at least a pixel (or called sub-pixel) P. Here for example, the pixel array includes a plurality of pixels P (FIG. 1A just shows a pixel P), and the pixels P are arranged into a matrix. Furthermore, the LCD panel 1 can further include a plurality of scan lines (not shown) and a plurality of data lines D, and the scan lines and the data lines D cross each other and are substantially perpendicular to each other to define the regions of the pixels P. As mentioned above, the extending direction of the data line D of this embodiment is substantially parallel to the first direction D1, and the extending direction of the scan line is substantially parallel to the second direction D2.

In addition to a liquid crystal layer 13 disposed between the first substrate 11 and the second substrate 12, the pixel P of this embodiment further includes a first electrode 141, a passivation layer 142, a second electrode 143, a planarization layer 144, an inter-layer dielectric layer 145 and a buffer layer 146. The buffer layer 146, the inter-layer dielectric layer 145, the planarization layer 144, the second electrode 143, the passivation layer 142 and the first electrode 141 are formed sequentially, from bottom to top, on the side of the first substrate 11 facing the second substrate 12.

The buffer layer 146 is disposed on the first substrate 11, and the inter-layer dielectric layer 145 covers the buffer layer 146. The adjacent two data lines D are disposed on the inter-layer dielectric layer 145 and on the two sides of the pixel P. The planarization layer 144 covers the data line D, and the second electrode 143 is disposed on the planarization layer 144. Moreover, the passivation layer 142 covers the second electrode 143 and the first electrode 141 is disposed on the passivation layer 142. Therefore, the second electrode 143 can be disposed between the passivation layer 142 and the planarization layer 144, and the passivation layer 142 is disposed between the first electrode 141 and the second electrode 143, so as to avoid the short circuit of the second electrode 143 with the first electrode 141. The materials of the passivation layer 142, planarization layer 144, inter-layer dielectric layer 145 and buffer layer 146 include, for example, SiOx, SiNx or other insulating materials, but this invention is not limited thereto. The first electrode 141 and the second electrode 143 are both a transparent conductive layer, and the materials thereof are, for example but not limited to, indium-tin oxide (ITO) or indium-zinc oxide (IZO). In this embodiment, the first electrode 141 is a pixel electrode and electrically connected with (not shown) the data line D, and the second electrode 143 is a common electrode. In this embodiment, since the second electrode 143 is a continuous layer structure and covers the planarization layer 144 and the data lines, the electric field formed due to the different driving voltages of the two adjacent data lines D will be shielded by the continuous second electrode (common electrode) 143 so as not to affect the operation of the first electrode (pixel electrode) 141, so favorably, the area of the second electrode 143 is larger than that of the first electrode 141. However, in other embodiments, the first electrode 141 may be a common electrode while the second electrode 143 is a pixel electrode.

The pixel P can further include a black matrix layer BM and a color filter layer 147. The black matrix layer BM is disposed between first substrate 11 and the second substrate 12, and is disposed corresponding to the data lines D. The black matrix layer BM is made by opaque material, such as resin or metal (e.g. Cr, chromium oxide, or Cr—O—N compound) for example. In this embodiment, the black matrix layer BM is disposed on the side of the second substrate 12 facing the first substrate 11 and over the data lines D along the first direction D1. Accordingly, the black matrix layer BM can cover the data lines D in a top view of the LCD panel 1. Since the black matrix layer BM is opaque, a corresponding opaque area can be formed on the second substrate 12 so as to define a transparent area (i.e. the area corresponding to the color filter layer 147). The color filter layer 147 is disposed on the side of the second substrate 12 facing the first substrate 11 or disposed on the first substrate 11. In this embodiment, the black matrix layer BM and the color filter layer 147 are both disposed on the second substrate 12, and the color filter layer 147 is disposed between the adjacent portions of the black matrix layer BM. In other embodiments, the black matrix layer BM or the color filter layer 147 may be disposed on the first substrate 11 for making a BOA (BM on array) substrate or a COA (color filter on array) substrate. To be noted, the above-mentioned structure of the substrate is just for example but not for limiting the scope of the invention.

Moreover, the pixel P of this embodiment can further include a protection layer 148 (e.g. over-coating), which can cover the black matrix layer BM and the color filter layer 147. The protection layer 148 can include photoresist material, resin material or inorganic material (e.g. SiOx/SiOx), protecting the black matrix layer BM and the color filter layer 147 from being damaged during the subsequent processes. Furthermore, the pixel P can further include alignment layers 151, 152. The alignment layer 151 is disposed on the first substrate 11 and covers the first electrode 141 and the passivation layer 142, and the alignment layer 152 is disposed on the second substrate 12 and covers the protection layer 148, and besides, the liquid crystal layer 13 is disposed between the alignment layers 151, 152.

When the scan lines of the LCD panel 1 receive a scan signal sequentially, the thin film transistor (TFT) (not shown) corresponding to each of the scan lines can be enabled. Then, the data signals can be transmitted to the corresponding pixel electrodes through the data lines D and the LCD panel 1 can display images accordingly. In this embodiment, the over-drive voltage can be transmitted to the first electrode 141 of each of the pixels P through each of the data lines D, and an electric filed can be thus formed between the first electrode 141 and the second electrode 143 to drive the LC molecules of the liquid crystal layer 13 to rotate on the plane that is in the first direction D1 and the second direction D2. Therefore, the light can be modulated and the LCD panel 1 can display images accordingly.

As shown in FIG. 1B, the first electrode (or abbreviated to the electrode) 141 of this embodiment is a line-symmetry structure to have a symmetry axis L. Herein, the “line-symmetry structure” indicates the parts of the first electrode 141 on the two sides of the symmetry axis L are symmetric with each other. Moreover, the first electrode 141 includes at least a first electrode portion 1411 extended towards the first direction D1. Herein for example, the first electrode 141 includes a first electrode portion 1411 extended towards the first direction D1, and the first direction D1 is also parallel to the symmetry axis L. For example, the first electrode portion 1411 is bar-like shape. In this embodiment, the first direction D1 and the alignment direction A of the alignment layer 151 are substantially parallel to each other. The alignment direction A is just the projection of the long axis direction of the LC molecules on the first substrate 11 during the rubbing process or photo alignment process. In other words, in this embodiment, the alignment direction A is substantially parallel to the extending direction of the data line D and perpendicular to the extending direction (second direction D2) of the scan line. However, for the tolerance of the process, the included angle between the symmetry axis L and the alignment direction A of the alignment layer 151 is defined as less than or equal to 2 degrees (i.e. 0°≦included angle≦2°) in this embodiment. In one embodiment, the black matrix layer BM can cover a part of the bar-like first electrode portion 1411 to improve the transmittance.

In this embodiment, the first electrode portion 1411 includes two opposite sides L1, L2. Along the second direction D2, and the two opposite sides L1, L2 are equidistant from the adjacent data line D (not shown in FIG. 1B). Moreover, the included angle (not marked) formed between the tangent direction at one point of the sides L1, L2 and the symmetry axis L is between 0° and 10°. In other words, although the first electrode portion 1411 is a bar-like electrode extended towards the first direction D1, the sides L1, L2 thereof are not both parallel to the symmetry axis L (maybe one is parallel and the other is not), so that the included angle between the tangent direction of at least a part of the sides L1, L2 and the symmetry axis L is between 0° and 10° (larger than 0° and smaller than 10°). Thereby, when the first electrode 141 is supplied with the driving voltage, the rotation rate of the LC molecules can be faster than the case of the completely parallel sides.

Moreover, the first electrode 141 of this embodiment further includes a second electrode portion 1412 connected with the first electrode portion 1411, and the first direction D1 is the direction away from the second electrode portion 1412. The second electrode portion 1412 is configured with at least a contact hole H, and the first electrode 141 is electrically connected with the TFT (not shown) corresponding to the pixel P through the contact hole H. Herein, the TFT is the driving TFT of the pixel P, and when the TFT is enabled, the gray-level voltage of the pixel P will be transmitted to the first electrode 141 through the source or drain of the TFT. Furthermore, in the second direction D2, the first electrode portion 1411 adjacent to the second electrode portion 1412 has a first width d1, the first electrode portion 1411 far from the second electrode portion 1412 has a second width d2, and the first width d1 is greater than or equal to the second width d2 (d1≧d2). Moreover, in one embodiment, the first width d1 can be greater than the second width d2. In another embodiment, the first width d1 can be equal to the second width d2. When the first width d1 is greater than the second width d2, the rotation rate of the LC molecules can be faster than the case where the first width d1 is equal to the second width d2 (i.e. the response time of the LC molecules is shorter).

To be noted, in this embodiment, the alignment direction A of this embodiment is the direction from the contact hole H to the end of the first electrode portion 1411. In other words, if the rightward extending direction from the second direction D2 is regarded as 0°, the alignment direction A of this embodiment is the direction of the counterclockwise 90° (i.e. the upward extending direction in FIG. 1B). Therefore, the included angle formed between the first direction D1 and the alignment direction A is also less than or equal to 2°.

FIGS. 1C and 1D are schematic diagrams showing the rotation of the LC molecules in relation to the first electrode 141 in FIG. 1B when the pixel P is not supplied and supplied with the driving voltage, respectively.

As shown in FIG. 1D, when the driving voltage is applied, the rotation of the LC molecules shows symmetry in relation to the symmetry axis L. Besides, through the experimental demonstration, the additional disclination will not occur in the pixel P when the pixel P is driven by extended driving voltage, so that the transmittance can not be affected.

Moreover, from the experimental result on the design of the pixel P of this embodiment, it can be seen the additional disclination will be generated in the pixel P if the LC molecules have no pre-tilt angle, so that the transmittance is reduced. Therefore, the pre-tilt angle of the LC molecules of this embodiment needs to be larger than 0° and less than 5°. In other words, as shown in FIG. 1E, which is a schematic diagram showing the pre-tilt condition of the LC molecules of an embodiment, the third direction D3 is parallel to a normal direction of the first substrate 11, and the included angle θ formed between the normal direction of the first substrate 11 and the long axis direction D4 of the LC molecules needs to be between 85° and 90° (85°<θ<90°). Thereby, when the first electrode 141 of the pixel P is overdriven, the additional disclination won't be generated and the transmittance can't be reduced.

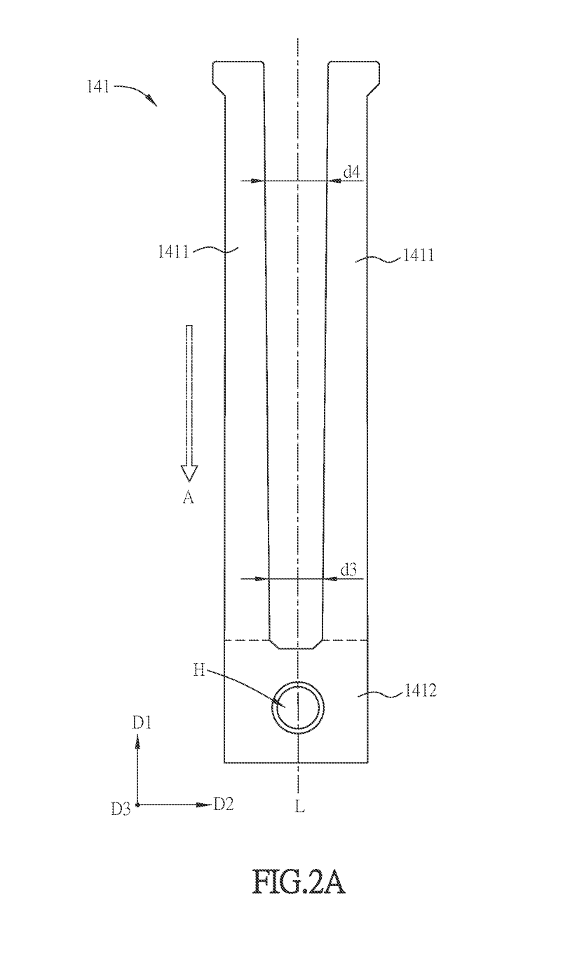

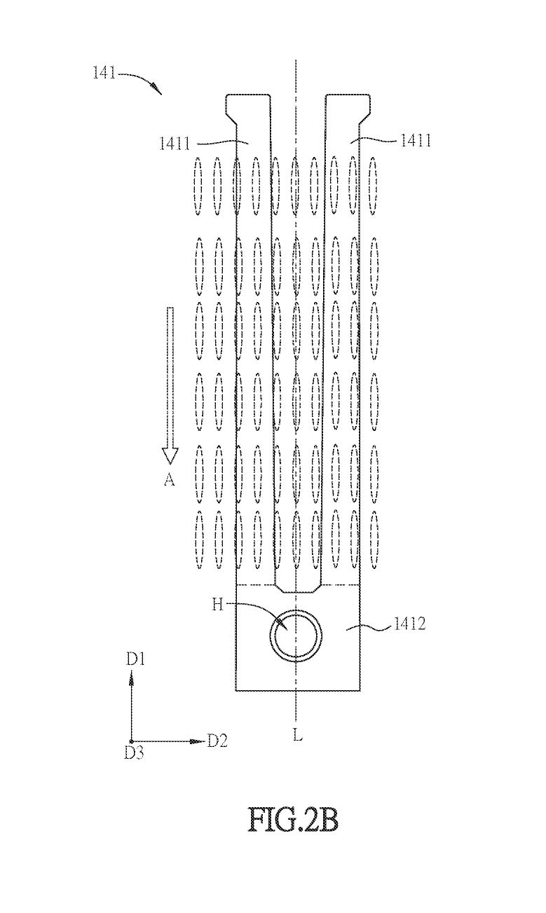

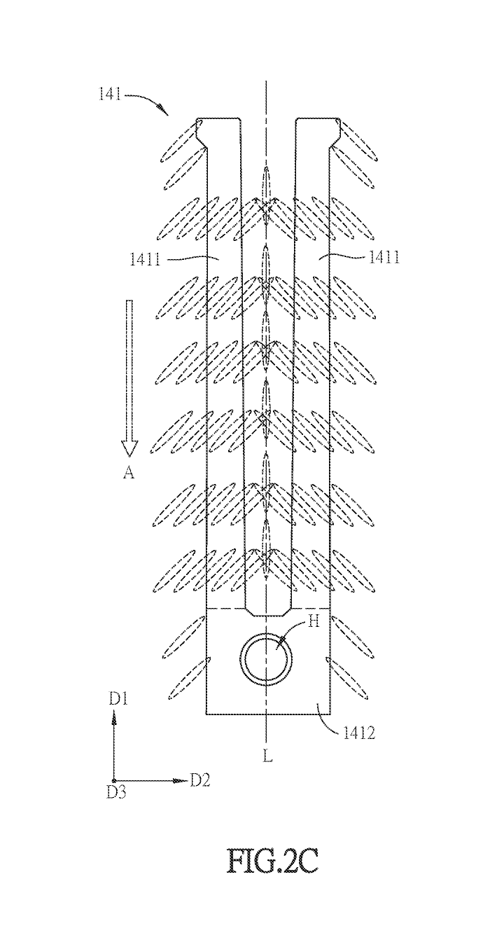

FIG. 2A is a schematic diagram of a first electrode 141 of another embodiment of the invention, and FIGS. 2B and 2C are schematic diagrams showing the rotation of the LC molecules in relation to the first electrode 141 in FIG. 2A when the pixel is not supplied and supplied with the driving voltage, respectively.

The main difference from the first electrode 141 in FIG. 1B is that the first electrode 141 in FIG. 2A includes two first electrode portions 1411 and a second electrode portion 1412 connected with the first electrode portions 1411. For example, the first electrode portions are bar-like shape. The included angle between the symmetry axis L and the alignment direction A of the alignment layer 151 is less than or equal to 2 degrees (i.e. 0°≦included angle≦2°). In this embodiment, the alignment direction A is from the end of the first electrode portion 1411 to the contact hole H, so that the included angle between the first direction D1 and the alignment direction A of the alignment layer 151 is larger than or equal to 178° and less than or equal to 182°. In other words, if the rightward extending direction from the second direction D2 is regarded as 0°, the alignment direction A of this embodiment is favorably the direction of the counterclockwise 270° (i.e. the downward extending direction in FIG. 2A). The reason thereof is that the pixel could have additional disclinations with the design of the first electrode 141 including two first electrode portions 1411, by the experimental demonstration, if the alignment direction A is the direction of the counterclockwise 90°.

Furthermore, in this embodiment, the interval d3 between the adjacent first electrode portions 1411 near the second electrode portion 1412 is less than the interval d4 between the adjacent first electrode portions 1411 far from the second electrode portion 1412 (the first electrode 141 has a U-shaped or V-shaped divergent form). In other words, the first electrode portions 1411 farther from the contact hole H have a larger interval in the second direction D2. Moreover, although the first electrode portions 1411 are bar-like electrodes extended towards the first direction D1, the sides adjacent to each other thereof are not all parallel to the first direction D1. Moreover, one of the first electrode portions 1411 has two opposite sides, and one of the opposite sides away from the symmetry axis L is substantially parallel to the alignment direction A. In other words, the included angle between the inner side (the side adjacent to the symmetry axis L) of the first electrode portion 1411 and the symmetry axis L is between 0° and 10° (not marked), and the outer side (the side away from the symmetry axis L) of the first electrode 141 is substantially parallel to the alignment direction A.

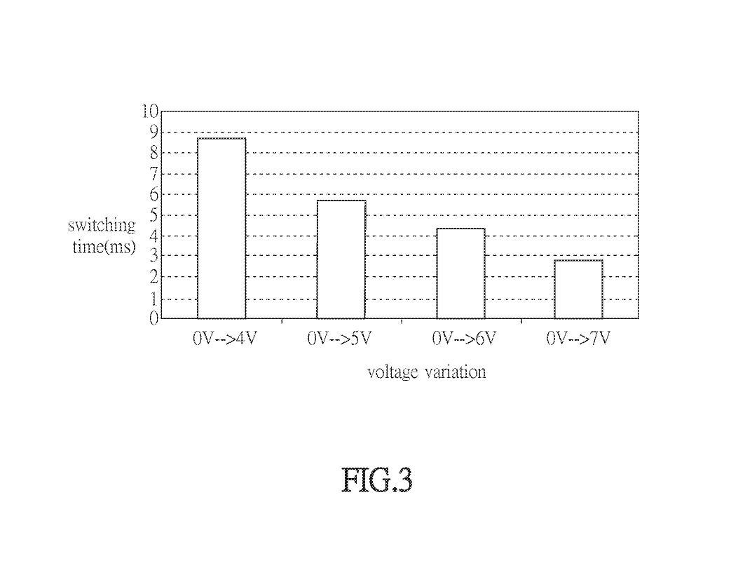

FIG. 3 is a schematic diagram showing the switching time of the LC molecules with the varied driving voltage of the pixel transmitted to the first electrode 141 in FIG. 2A according to an embodiment of the invention.

In this embodiment, the driving voltage is 4V when the pixel transmittance reaches the maximum. Therefore, the extended overdrive technique corresponds to the driving voltage higher than 4V (white voltage). As shown in FIG. 3, the switching time of the LC molecules in the case of the driving voltage changed from the beginning 0V to 7V (higher than 4V) is obviously shorter than that in the case of the driving voltage changed from 0V to 4V. Besides, even though the driving voltage reaches 7V, the LC molecules of the pixel have no more abnormal arrangement (i.e. disclination) by the experimental demonstration. Therefore, the additional disclination won't be generated and the panel transmittance is thus not reduced, so the side effect (lower transmittance) will be eliminated when the LCD panel is with fast response time.

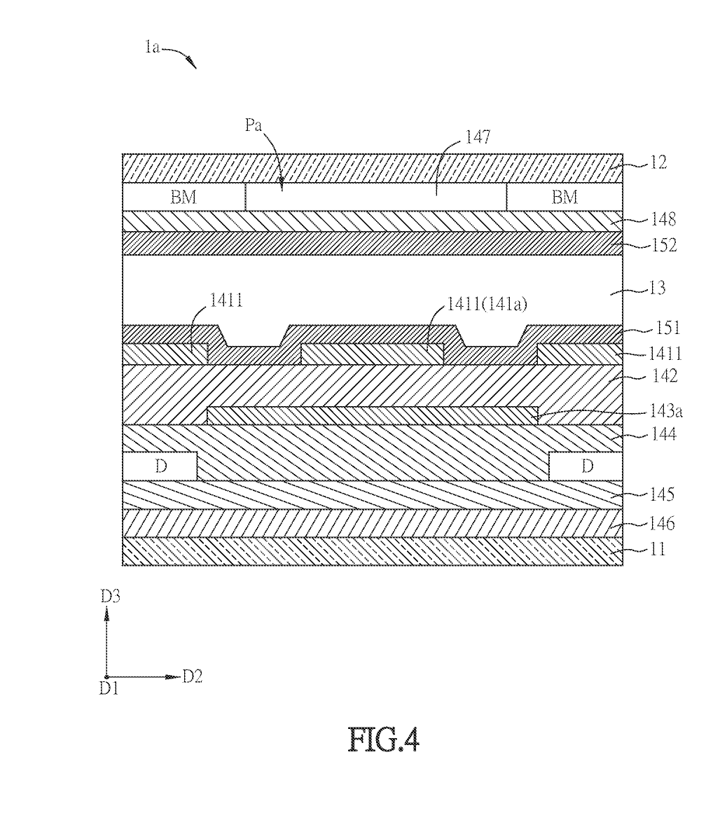

FIG. 4 is a schematic sectional diagram of an LCD panel 1a of another embodiment of the invention.

In this embodiment, the first electrode 141a of the pixel Pa of the LCD panel 1a also has a line-symmetry structure, and the first direction D1 which the first electrode portion 1411 is extended towards is substantially parallel to the alignment direction A of the alignment layer 151.

The main difference between the LCD panel 1a of this embodiment and the LCD panel 1 in FIG. 1A is that the first electrode 141a of the pixel Pa of the LCD panel 1a is a common electrode and the second electrode 143a is a pixel electrode.

Other technical features of the LCD panel 1a can be comprehended by referring to the above-mentioned LCD panel 1 and therefore the related illustration is omitted here for conciseness.

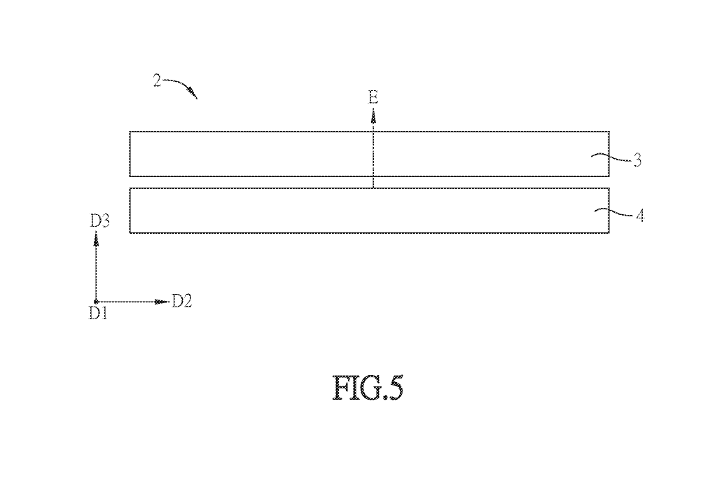

FIG. 5 is a schematic diagram of an LCD device 2 of an embodiment of the invention.

As shown in FIG. 5, the LCD device 2 includes an LCD panel 3 and a backlight module 4 disposed opposite the LCD panel 3. The LCD panel 3 can be any of the above-mentioned LCD panels 1, la or their variation so the description thereof is omitted here. When the backlight module 4 emits the light E passing through the LCD panel 3, the pixels of the LCD panel 3 can display colors to form images accordingly.

Summarily, in the LCD panel of the invention, the pixel is disposed between the first substrate and the second substrate and includes an alignment layer and a first electrode. The alignment layer is disposed on the first electrode, and the first electrode is a line-symmetry structure and has a symmetry axis and is disposed on the first substrate. Besides, the first electrode includes at least a first electrode portion extended towards a first direction, and the included angle formed between the symmetry axis and the alignment direction of the alignment layer is less than or equal to 2°. By the electrode structure of the pixel and the relation between the first electrode portion of the first electrode and the alignment direction of the alignment layer, the pixel won't have the additional disclination and the transmittance is thus not reduced when the LCD panel is driven by the overdrive technique, especially by the extended overdrive voltage. Therefore, the LCD panel of this invention can accelerate the response of the LCD molecules and reduce the switching time on the premise that the transmittance is not reduced, and therefore the motion blur problem can be improved and the display quality can be enhanced.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A liquid crystal display (LCD) panel comprising:
a first substrate and a second substrate;
a liquid crystal layer disposed between the first substrate and the second substrate;
a first electrode disposed on the first substrate and comprising at least a first electrode portion extended toward a first direction, wherein the first electrode is a line-symmetry structure and has a symmetry axis; and
an alignment layer disposed on the first electrode, wherein an included angle formed between the symmetry axis of the first electrode and an alignment direction of the alignment layer is less than or equal to 2°, and the liquid crystal display (LCD) panel is driven by an overdrive technique.

2. The LCD panel as recited in claim 1, wherein the first electrode is a pixel electrode or a common electrode of the LCD panel.

3. The LCD panel as recited in claim 1, wherein the first electrode portion has two opposite sides, and the included angle between the tangent direction at a point of one of the sides and the symmetry axis of the first electrode is between 0° and 10°.

4. The LCD panel as recited in claim 1, wherein the first electrode portion is a bar-like shape.

5. The LCD panel as recited in claim 4, wherein the first electrode portion has two opposite sides, and the included angle between one of the sides and the symmetry axis of the first electrode is between 0° and 10°.

6. The LCD panel as recited in claim 1, wherein the first electrode further includes a second electrode portion connected with the first electrode portion, a contact hole is disposed on the second electrode portion, the first electrode portion adjacent to the contact hole has a first width, the first electrode portion far from the contact hole has a second width, and the first width is greater than or equal to the second width.

7. The LCD panel as recited in claim 1, wherein the included angle formed between the first direction and the alignment direction is less than or equal to 2°.

8. The LCD panel as recited in claim 1, wherein the first electrode comprises a plurality of the first electrode portions and a second electrode portion connected with the first electrode portions, the included angle formed between the first direction and the alignment direction of the alignment layer is between 178° and 182°.

9. The LCD panel as recited in claim 8, wherein the interval between the adjacent first electrode portions near the second electrode portion is less than that far from the second electrode portion.

10. The LCD panel as recited in claim 8, wherein one of the first electrode portions has two opposite sides, and one of the opposite sides away from the symmetry axis is substantially parallel to the alignment direction.

11. The LCD panel as recited in claim 1, wherein an included angle formed between a normal direction of the first substrate and a long axis direction of the liquid crystal molecules of the liquid crystal layer is larger than 85° and smaller than 90°.

12. The LCD panel as recited in claim 1, which is a fringe field switching (FFS) LCD panel or an in-plane switch (IPS) LCD panel.

13. The LCD panel as recited in claim 1, which is driven by an extended overdrive technique.

14. The LCD panel as recited in claim 1, further comprising:
a data line electrically connected with the first electrode, wherein the first direction is substantially parallel to the data line.

15. The LCD panel as recited in claim 1, further comprising:
a second electrode disposed between the first electrode and the first substrate, wherein the area of the second electrode is larger than that of the first electrode.

16. The LCD panel as recited in claim 1, further comprising:
a black matrix layer disposed between the first substrate and the second substrate, wherein a part of the first electrode portion is covered by the back matrix layer.
